(19) United States
(12) Patent Application Publication
(10) Pub. No.: US 2024/0263948 A1
(43) Pub. Date: Aug. 8, 2024

(54) TRAVEL CONTROL DEVICE

(71) Applicant: TOYOTA JIDOSHA KABUSHIKI KAISHA, Toyota-shi (JP)

(72) Inventor: Shigehiro SUGIHIRA, Sunto-gun (JP)

(73) Assignee: TOYOTA JIDOSHA KABUSHIKI KAISHA, Toyota-shi (JP)

(21) Appl. No.: 18/543,267

(22) Filed: Dec. 18, 2023

(30) Foreign Application Priority Data
Feb. 6, 2023 (JP) 2023-015943

(51) Int. Cl. G01C 21/28

(52) U.S. Cl. CPC G01C 21/28

(57) ABSTRACT

The travel control device includes a processor, the processor generates a target route to a destination, estimates the self-position of the vehicle, calculates a target destination on the target route, and calculates a viewing angle in front of the vehicle and a vehicle A target point candidate including a target point is generated within a predetermined distance and a predetermined angle from the vehicle's self-position based on the look ahead distance from the self-position to the target reach point, and during the search for the target point candidate When the target point is outside the front viewing angle of the vehicle, the point at that time is calculated as the target point.

### CROSS-REFERENCE TO RELATED APPLICATION

This application claims priority to Japanese Patent Application No. 2023-015943 filed on Feb. 6, 2023, incorporated herein by reference in its entirety.

### BACKGROUND

### 1. Technical Field

The present disclosure relates to a travel control device.

### 2. Description of Related Art

Japanese Unexamined Patent Application Publication No. 2005-335588 (JP 2005-335588 A) describes a technology in which a driver's steering operation is treated as a feedback control operation for a predicted vehicle position and a predicted vehicle behavior at a look ahead point and a travel situation in which the vehicle behavior changes is reproduced with a vehicle model. In this technology, when the vehicle is on a target course set in a driver model, the look ahead point is set as a point that is a predetermined look ahead distance away from the vehicle. In this technology, assuming that the vehicle travels to the look ahead point while maintaining a current vehicle posture, a lateral displacement of the vehicle and a deviation from the target course as well as a yaw angle displacement and a deviation from a target yaw angle are then detected. In this technology, a steering angle to be applied to the vehicle model is then calculated by feedback control using a position shift amount and a position deviation gain as well as a yaw angle shift amount and a yaw angle deviation gain.

### SUMMARY

In JP 2005-335588 A, however, it is difficult to accurately estimate the shape of the target course when the route coordinate point sequence of the preset target course is not set smoothly, for example, in a case of a curve. There is room for improvement.

The present disclosure has been made in view of the above. An object of the present disclosure is to provide a travel control device that can accurately estimate the shape of a target course.

In order to solve the above problem and achieve the object, a travel control device according to the present disclosure is
a travel control device including a processor and configured to control travel of a vehicle.
   The processor is configured to:
generate a target route to a destination;
estimate a self-position of the vehicle;
calculate a target reach point on the target route;
generate target point candidates including a target point within a predetermined distance and a predetermined angle from the self-position based on a forward viewing angle of the vehicle and a look ahead distance from the self-position to the target reach point; and
calculate, as the target point, a point at a timing when the target point is outside the forward viewing angle of the vehicle during a search for the target point candidates.

The present disclosure attains such an effect that the shape of the target course can be estimated accurately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a travel control device according to one embodiment;

FIG. 2 is a flowchart showing an outline of processing executed by a travel control device according to one embodiment;

FIG. 3 is a diagram schematically showing the positions of target points when the vehicle is traveling on a route with good visibility;

FIG. 4 is a plan view showing the position of the target point under the situation of FIG. 3;

FIG. 5 is a diagram schematically showing the position of the target point when the vehicle is traveling on a route with poor visibility; and

FIG. 6 is a plan view showing the positions of the target points under the conditions of FIG. 5.

### DETAILED DESCRIPTION OF EMBODIMENTS

A travel control device according to an embodiment of the present disclosure will be described below with reference to the drawings. It should be noted that the present disclosure is not limited by the following embodiments. Also, the same parts are denoted by the same reference numerals in the following description.

### Overview of the Travel Control Device

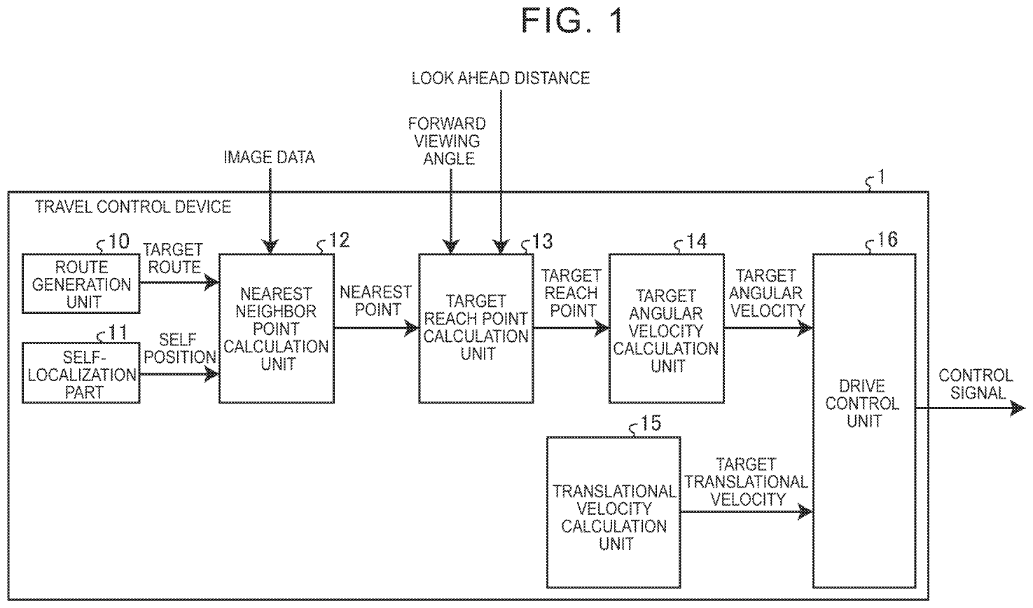

FIG. 1 is a diagram showing a schematic configuration of a travel control device according to one embodiment. A travel control device 1 shown in FIG. 1 is mounted on a vehicle. This vehicle is assumed to be a Hybrid Electric Vehicle (HEV), a Plug-in Hybrid Electric Vehicle (PHEV), a Battery Electric Vehicle (BEV), a Fuel Cell Electric Vehicle (FCEV), or the like.

The travel control device 1 is realized using a processor having hardware. The hardware includes, for example, memory, Central Processing Unit (CPU), Digital Signal Processor (DSP), Field-Programmable Gate Array (FPGA) and Graphics Processing Unit (GPU). In the following, an example in which the travel control device 1 uses a simple tracking algorithm (hereinafter simply referred to as “PutePersuite”) in route following when an autonomous mobile vehicle travels a set target route to a destination will be described. . This PutePersuite controls the route followability of the vehicle by using the look ahead distance as one of the control parameters.

The travel control device 1 controls each part that constitutes the vehicle. The travel control device 1 loads a program stored in a storage medium into a work area of a memory, executes the program, and controls each component through the execution of the program, thereby realizing a function that meets a predetermined purpose. Specifically, the travel control device 1 includes a route generation unit 10, a self-position estimation unit 11, a nearest neighbor point calculation unit 12, a target reach point calculation unit 13, a target angular velocity calculation unit 14, a translational velocity calculation unit 15, and a drive control unit 16.

A route generation unit 10 generates a target route to a destination. The route generation unit 10 outputs this target route to the nearest neighbor point calculation unit 12. Specifically, the route generation unit 10 generates a target route to a destination according to a user's operation instruction from an external device such as a touch panel or a mobile terminal or an instruction from an external server. Of course, the route generation unit 10 may automatically generate the target route to the destination. In this case, the route generation unit 10 generates a target route to the destination based on the image data generated by the imaging device provided in the vehicle, the self-position of the vehicle itself of the self-position estimation unit 11 described later, and the current direction of the vehicle.

The self-position estimation unit 11 estimates the self-position of the vehicle itself. Self-position estimation unit 11 outputs this estimation result to nearest neighbor point calculation unit 12. Here, the self-position is position information of a coordinate system that serves as a reference for representing the current azimuth of the vehicle, and the current longitude and latitude of the vehicle. Specifically, the self-position estimation unit 11 uses a Global Positioning System (GPS) sensor, which is an example of a navigation satellite system (NSS), or a Light Detection And Ranging (LiDAR) capable of generating ranging data.

The nearest neighbor point calculation unit 12 calculates the nearest point from the self position on the target route, based on image data captured by an imaging device provided in the vehicle, the target route input from the route generation unit 10, and the self-position input from the self-position estimation unit 11. Then, the nearest neighbor point calculation unit 12 outputs the calculated nearest neighbor point to the target reach point calculation unit 13. Specifically, the nearest neighbor point calculation unit 12, based on two or more image data with different imaging times, the target route, the self position, and a learned model or rule learned in advance by machine learning, the self on the target route compute the nearest point from the position. As a method for searching for the closest point, a nearest point search for searching for the nearest point of the closest point in the metric space, for example, a linear search or the like is used. Also, the method of constructing the learned model used by the nearest neighbor point calculation unit 12 is not particularly limited. For example, various machine learning methods such as deep learning using neural networks, support vector machines, decision trees, naive Bayes, and k nearest neighbors can be used.

The target reach point calculation unit 13 calculates the forward viewing angle in front of the vehicle obtained from various sensors provided on the vehicle, and the distance from the self position of the vehicle to the target reach point in front of the vehicle obtained from various sensors provided on the vehicle. Target point candidates are calculated within a predetermined distance or a predetermined angle from the self-position of the vehicle based on the look ahead distance and the nearest neighbor point calculated by the nearest neighbor point calculation unit 12. Specifically, the target reach point calculation unit 13 searches for a target point whose distance from the self-position of the vehicle is the Look Ahead Distance. Then, the target reach point calculation unit 13 determines whether or not the target point is outside the front viewing angle during the search for the target point. When the target point is not outside the front viewing angle, the target reach point calculation unit 13 calculates (sets) the target point by increasing the look ahead distance to a predetermined distance. On the other hand, if the target point is outside the front viewing angle, the target reach point calculation unit 13 reduces the look ahead distance below a predetermined distance, and calculates (sets) the point at the time when the target point is outside the front viewing angle as the target point. Further, the target reach point calculation unit 13 calculates the target reach point from the front viewing angle in front of the vehicle obtained from various sensors provided in the vehicle, and the vehicle's own position in front of the vehicle obtained from various sensors provided in the vehicle. Target point candidates are sequentially calculated for each predetermined distance from the self-position of the vehicle, based on the look ahead distance to and the nearest neighbor point calculated by the nearest neighbor point calculation unit 12.

The target angular velocity calculation unit 14 calculates a target angular velocity for controlling the direction of the vehicle based on the target reach point calculated by the target reach point calculation unit 13. The target angular velocity calculation unit 14 outputs the calculated target angular velocity to the drive control unit 16.

The translational velocity calculation unit 15 calculates a target translational speed of the vehicle. The translational velocity calculation unit 15 outputs the calculated target translational velocity to the drive control unit 16.

Drive control unit 16 generates a control signal for controlling the speed of the vehicle based on the target angular velocity calculated by target angular velocity calculation unit 14 and the target translational velocity calculated by translational velocity calculation unit 15. The drive control unit 16 outputs this control signal to a vehicle steering mechanism (not shown).

### Processing of the Travel Control Device

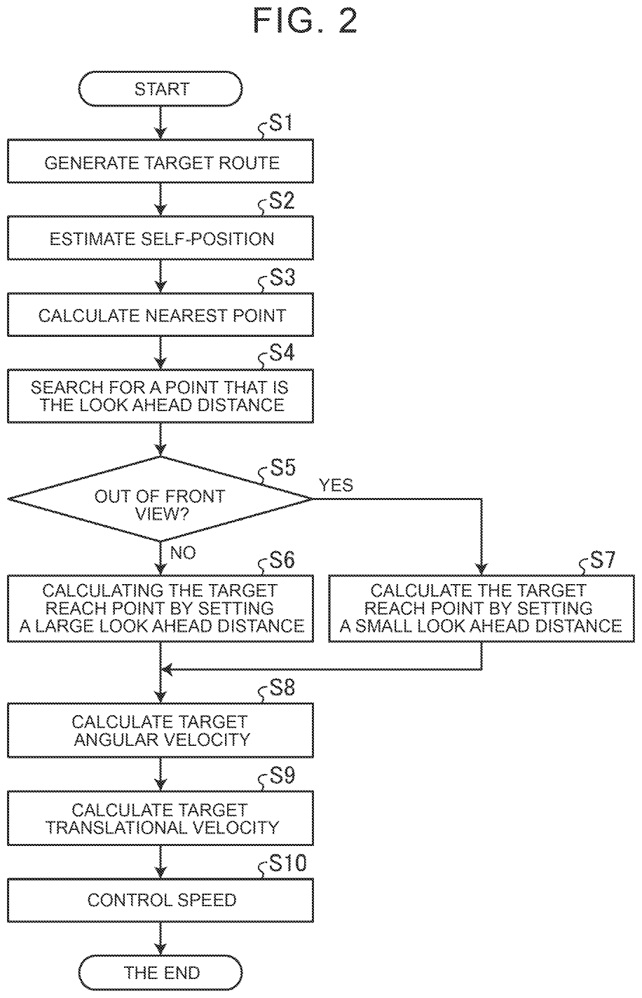

Next, processing executed by the travel control device 1 will be described. FIG. 2 is a flowchart showing an overview of the processing executed by the travel control device 1

As shown in FIG. 2, the route generation unit 10 first generates a target route to a destination (S1). In this case, the route generation unit 10 outputs the generated target route to the destination to the nearest neighbor point calculation unit 12.

Subsequently, the self-position estimation unit 11 estimates the self-position of the vehicle itself (S2). In this case, self-position estimation unit 11 outputs the estimated self-position to nearest neighbor point calculation unit 12.

After that, the nearest neighbor point calculation unit 12 calculates the target route based on the image data captured by the imaging device provided in the vehicle, the target route input from the route generation unit 10, and the self-position input from the self-position estimation unit 11. The nearest neighbor point from the self position on the top is calculated (S3). In this case, the nearest neighbor point calculation unit 12 outputs the calculated nearest point to the target reach point calculation unit 13.

Subsequently, the target reach point calculation unit 13 searches for a point at which the distance from the self position of the vehicle is the look ahead distance (target reach point) within the predetermined distance of the predetermined angle from the self position of the vehicle, based on the forward viewing angle in front of the vehicle obtained from various sensors provided in the vehicle, the look ahead distance from the self position of the vehicle to the target reach point in front of the vehicle obtained from the various sensors provided in the vehicle, and the nearest point calculated by the nearest neighbor point calculation unit 12 (S4).

After that, the target reach point calculation unit 13 determines whether or not the target point is outside the front viewing angle during the search for the target point (S5). If the target point is out of the forward viewing angle during the search for the target point (S5: Yes), the target reach point calculation unit 13 proceeds to S7. On the other hand, if the target point is not outside the front viewing angle during the search for the target point (S5: No), the target reach point calculation unit 13 proceeds to S6.

In S6, the target reach point calculation unit 13 calculates the target reach point that is a target point within a predetermined distance or a predetermined angle from the vehicle's own position by setting the look ahead distance to be larger than the predetermined distance, based on the forward viewing angle, the look ahead distance, and the nearest neighbor point.

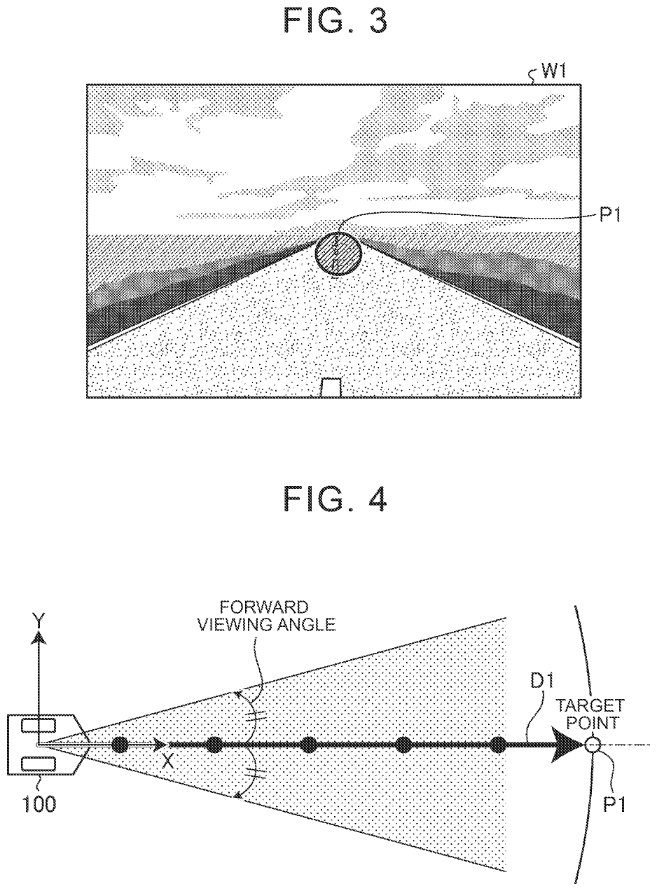

FIG. 3 is a diagram schematically showing the positions of target points when the vehicle is traveling on a route with good visibility. FIG. 4 is a plan view showing the positions of the target points under the conditions of FIG. 3. In FIG. 4, the horizontal axis indicates the traveling direction (x-axis), and the vertical axis indicates the direction perpendicular to the traveling direction (y-axis).

As shown in FIGS. 3 and 4, when the target point of the vehicle 100 is within the front viewing angle while the target reach point calculation unit 13 is searching for the target point, a case is explained in which the vehicle 100 is traveling on a straight road, for example. In this case, target reach point calculation unit 13 calculates the target reach point including at least target point P1 within a predetermined distance or a predetermined angle from the self-position of vehicle 100 by setting the look ahead distance D1 to be larger than a predetermined distance based on the forward viewing angle, the look ahead distance, and the nearest point. As a result, the vehicle 100 can travel while following the target route while ensuring stability when traveling straight.

Returning to FIG. 2, the description after S7 is continued.

In S7, the target reach point calculation unit 13 calculates the target point, which is the target point, within a predetermined distance or a predetermined angle from the vehicle's own position by setting the look ahead distance D1 to be smaller than a predetermined distance, based on the forward viewing angle, the look ahead distance, and the nearest point.

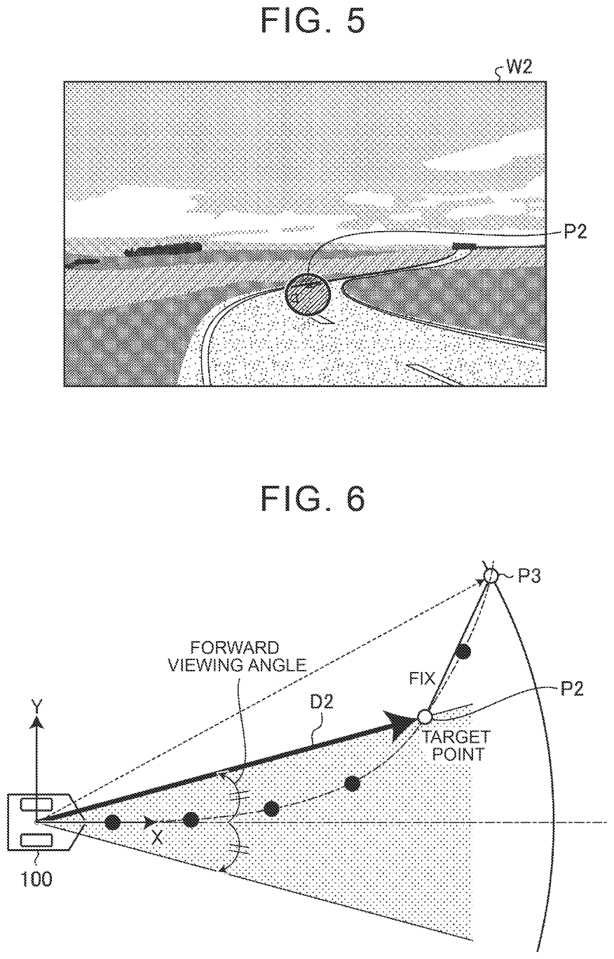

FIG. 5 is a diagram schematically showing the positions of target points when the vehicle is traveling on a route with poor visibility. FIG. 6 is a plan view showing the positions of the target points under the conditions of FIG. 5. In addition, in FIG. 6, the horizontal axis indicates the traveling direction (x-axis). In FIG. 6, the vertical axis indicates the direction (y-axis) perpendicular to the traveling direction.

As shown in FIGS. 5 and 6, when the target point of the vehicle 100 is outside the front viewing angle while the target reach point calculation unit 13 is searching for the target point, for example, a case is explained in which the vehicle 100 travels on a curved road. In this case, target reach point calculation unit 13 calculates the target reach point including target point P2 within a predetermined distance or a predetermined angle from the self-position of vehicle 100 by setting the look ahead distance D2 to be smaller than the predetermined distance, and corrected target point P3 which is located outside the front viewing angle and which can be tracked from the target point P2, based on the look ahead distance, and the nearest neighbor point. As a result, the vehicle 100 can travel while following the target route while achieving both stability in a straight line and route followability in turning.

Returning to FIG. 2, the description after S8 is continued.

In S8, the target angular velocity calculation unit 14 calculates a target angular velocity for controlling the direction of the vehicle based on the target reach point calculated by the target reach point calculation unit 13. In this case, the target angular velocity calculation unit 14 outputs the calculated target angular velocity to the drive control unit 16.

Subsequently, the translational velocity calculation unit 15 calculates a target translational speed of the vehicle (S9). In this case, the translational velocity calculation unit 15 outputs the calculated target translational velocity to the drive control unit 16.

After that, the drive control unit 16 generates a control signal for controlling the speed of the vehicle based on the target angular velocity calculated by the target angular velocity calculation unit 14 and the target translational speed calculated by the translational velocity calculation unit 15 (S10). In this case, the drive control unit 16 outputs a control signal to a steering mechanism (not shown) of the vehicle.

According to the embodiment described above, the target reach point calculation unit 13 generates the target point candidate including the target point within a predetermined distance or a predetermined angle from the self-position of the vehicle, based on the forward viewing angle in front of the vehicle, the look ahead distance from the self position of the vehicle to the target reach point, and the nearest point calculated by the nearest neighbor point calculation unit 12. If the target point falls outside the front viewing angle of the vehicle during the search for the target point candidate, the target reach point calculation unit 13 calculates the point at that time as the target point. This makes it possible to accurately estimate the shape of the target course.

Further, according to one embodiment, when the vehicle travels on a curve, the look ahead distance is set small, and the target point is set close to the own position (own machine position). Therefore, it is possible to improve the route followability of the target route while reducing shortcuts of the vehicle.

Further, according to one embodiment, when the vehicle travels in a straight line, the look ahead distance is set large, and the target point is set far from the own position (own machine position). Therefore, the stability of the route versus fertilization of the target route when traveling straight can be achieved.

In addition, according to one embodiment, since processing such as differentiation of the path shape becomes unnecessary, the influence of shape disturbance can be reduced.

### Other Embodiments

Further, although the line control device according to one embodiment is provided in the vehicle, the functions of the travel control device may be realized by one server.

In addition, in the travel control device according to the embodiment, the “unit” described above can be read as “means” or “circuit”. For example, the drive control unit can be read as drive control means or a drive control circuit.

Further, the program to be executed by the travel control device according to one embodiment is stored and provided in a computer-readable storage medium by a computer such as a compact disc (CD)-read only memory (ROM), a flexible disc (FD), a

CD-R, a digital versatile disk (DVD), a USB medium, and a flash memory in an installable format or a file data format that is executable.

Note that in the description of the flowchart in this specification, expressions such as “first”, “after”, and “following” are used to clearly indicate the anteroposterior relationship of processing between steps. However, the order of processing required to implement this embodiment is not uniquely defined by those expressions. That is, the order of processing in the flowchart charts described herein may be changed within a consistent range.

Further effects and modifications can be easily derived by those skilled in the art. The broader aspects of the disclosure are not limited to the specific details and representative embodiments shown and described above. Accordingly, various changes may be made without departing from the spirit or scope of the general inventive concept defined by the appended claims and equivalents thereof.

Some of the embodiments of the present application have been described in detail above with reference to the drawings. However, these are only examples, and the present disclosure can be implemented in other forms with various modifications and improvements based on the knowledge of those skilled in the art, including the embodiments described in the disclosure section of the present disclosure.

What is claimed is:

1. A travel control device comprising a processor and configured to control travel of a vehicle, wherein the processor is configured to:
generate a target route to a destination;
estimate a self-position of the vehicle;
calculate a target reach point on the target route;
generate target point candidates including a target point within a predetermined distance and a predetermined angle from the self-position based on a forward viewing angle of the vehicle and a look ahead distance from the self-position to the target reach point; and
calculate, as the target point, a point at a timing when the target point is outside the forward viewing angle of the vehicle during a search for the target point candidates.

2. The travel control device according to claim 1, wherein the processor is configured to:
determine whether the target point is outside the forward viewing angle;
when determination is made that the target point is outside the forward viewing angle, calculate the target point by setting the look ahead distance to be smaller than the predetermined distance; and
when determination is made that the target point is not outside the forward viewing angle, calculate the target point by setting the look ahead distance to be larger than the predetermined distance.
